(19) United States
(12) Patent Application Publication
(10) Pub. No.: US 2026/0094993 A1
(43) Pub. Date: Apr. 2, 2026

(54) LOCKING PLUG FOR POWER ADAPTER

(71) Applicant: Apple Inc., Cupertino, CA (US)

(72) Inventors: Paul Z. Yuan, San Jose, CA (US); Clayton R. Woosley, San Jose, CA (US); Min Chul Kim, San Jose, CA (US); Kwangwoo Yeum, Sunnyvale, CA (US); Sean Atwood, Mountain View, CA (US)

(73) Assignee: Apple Inc., Cupertino, CA (US)

(21) Appl. No.: 19/340,107

(22) Filed: Sep. 25, 2025

Related U.S. Application Data
(60) Provisional application No. 63/700,495, filed on Sep. 27, 2024.

(51) Int. Cl. H01R 13/629; H01R 13/62

(52) U.S. Cl. CPC H01R 13/629; H01R 13/6205

(57) ABSTRACT

Examples can provide locking plugs that can lock to a power adapter and that can also be unlocked for removal from the power adapter. Different locking mechanisms can be included to prevent removal of the locking plug. A tool can be used to move these locking mechanisms and allow removal. The locking plug can be reattached as well. Examples can also provide retention features that can secure a plug to a power adapter during use. A retention force can be overcome allowing removal of the plug from the power adapter. The forces retaining a tab of a power adapter in a slot of a plug can be provided by a spring assembly in the slot. The forces can also or instead be provided by one or more springs in or associated with the tab.

### CROSS-REFERENCES TO RELATED APPLICATIONS

This application claims the benefit of U.S. Provisional Application No. 63/700,495, filed on Sep. 27, 2024, which is incorporated by reference.

### BACKGROUND

Power adapter systems can include a power adapter and a plug. The plug can include power prongs that can be inserted into a corresponding wall outlet. The power adapter can receive power from the plug. The power adapter can provide power using various connectors that can be located on the power adapter. In some such systems, the plug can be removable from the power adapter.

The ability to remove the plug from the power adapter can provide the ability to use the power adapter with plugs that are designed to be conforming with various standards in different countries. But sometimes it can be disadvantageous to be able to remove the plug from the power adapter. For example, the plug can become separated from the power adapter and misplaced. As a result, it can be desirable to be able to lock the plug to the power adapter.

In some circumstances, it can also be undesirable to lock a plug to a power adapter. Customer confusion can result, and unlocking tools can be misplaced. But it can still be undesirable for a plug to be too readily removed from a power adapter. For example, it can be undesirable for a plug to detach from a power adapter when the power adapter system is unplugged from a wall outlet. As a result, reliable retention features that can secure a plug to a power adapter can be desirable.

Thus, what is needed are plugs that can lock to a power adapter or otherwise be securely retained during use.

### SUMMARY

Accordingly, embodiments of the present invention can provide plugs that can lock to a power adapter or otherwise be securely retained during use. Different locking mechanisms can be used in these and other embodiments of the present invention. These can involve including a locking mechanism in the locking plug to prevent the removal of the locking plug. A tool can be used to move these locking mechanisms and allow the removal of the locking plug. The locking plug can be reattached as well.

In some circumstances, it can be undesirable to lock a plug to a power adapter. Customer confusion can result and unlocking tools can be lost. Instead of providing a locking feature, these and other embodiments of the present invention can provide retention features that can secure a plug to a power adapter. These retention features can provide a retention force that can secure the plug in place in the power adapter during use. This retention force can be overcome by a user wishing to remove the plug from the power adapter.

These retention features can include springs or other features that act to secure a tab on the power adapter in a slot in a housing of a plug. In these and other embodiments of the present invention, springs can be located in the slot in the plug to retain a tab on the power adapter. The springs can include a first spring having two arms. Each arm can include a side protrusion such that the two side protrusions and an end of the slot in the housing form a retention area for the tab on the power adapter. The springs can further include two inclined second springs that attach to ends of each arm of the first spring and extend towards the retention area and away from the first spring. The second springs can terminate in contacting surfaces. The contacting surfaces can engage and provide a force to a bottom of a head of the tab of the power adapter, thereby further securing the tab of the power adapter in place in the slot in the plug.

In this example, forces retaining a tab of a power adapter in a slot of a plug can be provided by springs in the slot. In these and other embodiments of the present invention, these forces can be provided by one or more springs in or associated with the tab. For example, a spring can be located in the tab. The tab can include a shaft and a head. The shaft can include a plunger, the plunger attached to the head. The head and plunger can be movable relative to the shaft. The shaft can be fixed to the power adapter. A spring can be positioned to provide a force acting to push the plunger, and therefore the head, towards the power adapter. The slot in the plug can include a recessed portion forming a retention area. Once the tab of the power adapter is positioned in the retention area, the force pushing the head towards the bottom of the slot in the housing and towards the power adapter can act to retain the tab of the power adapter in place.

The components of these power adapters and plugs can be formed of various materials. For example, the tabs, springs, and their constituent parts and other metallic portions of the power adapters can be formed by drawing, machining, stamping, forging, metal-injection molding, machining, micro-machining, 3-D printing, or other manufacturing process. These metallic portions can be formed of stainless steel, steel, copper, copper titanium, phosphor bronze, or other material or combination of materials. They can be plated or coated with one or more layers of nickel, palladium, palladium-nickel, gold, or other material or combination of materials.

The nonmetallic portions, such as the enclosure, housings, and their constituent parts and other nonmetallic portions can be formed using injection or other molding, 3-D printing, machining, or other manufacturing process. The nonmetallic portions can be formed of silicon or silicone, rubber, hard rubber, plastic, nylon, glass-filled nylon, elastomers, liquid-crystal polymers (LCPs), ceramics, polycarbonate, or other nonmetallic material or combination of materials.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates a locking plug and power adapter according to an embodiment of the present invention;

FIG. 2 illustrates a locking plug and power adapter with an unlock passage according to an embodiment of the present invention;

FIG. 3 illustrates a locking plug according to an embodiment of the present invention;

FIG. 4 illustrates another locking plug according to an embodiment of the present invention;

FIG. 5 illustrates another locking plug according to an embodiment of the present invention;

FIG. 6 illustrates another locking plug according to an embodiment of the present invention;

FIG. 7 illustrates another locking plug according to an embodiment of the present invention;

FIG. 8 illustrates a plug having a slot for a retention feature according to an embodiment of the present invention;

FIG. 9 illustrates a cutaway side-view of a plug having a slot and a retention feature according to an embodiment of the present invention;

FIG. 10 illustrates cutaway side-view of a portion of a plug having a slot and a retention feature according to an embodiment of the present invention;

FIG. 11 illustrates a retention feature for a plug according to an embodiment of the present invention;

FIG. 12 illustrates another retention feature for a plug according to an embodiment of the present invention;

FIG. 13 illustrates a side-view of another retention feature for a plug according to an embodiment of the present invention;

FIG. 14 is an oblique view of a retention feature for a plug according to an embodiment of the present invention;

FIG. 15 is a detailed view of a portion of a retention feature for a plug according to an embodiment of the present invention;

FIG. 16 illustrates another plug having a slot for a retention feature according to an embodiment of the present invention;

FIG. 17 illustrates a cutaway view of retention features for a plug according to an embodiment of the present invention;

FIG. 18 is an exploded view of a tab for a power adapter according to an embodiment of the present invention;

FIG. 19 and FIG. 20 illustrate a surface in a slot of a plug for a retention feature according to an embodiment of the present invention; and

FIG. 21 illustrates a protection structure for a surface in a slot of a plug for a retention feature according to an embodiment of the present invention; and

FIG. 22 illustrates another retention feature for a plug according to an embodiment of the present invention.

### DESCRIPTION OF ILLUSTRATIVE EMBODIMENTS

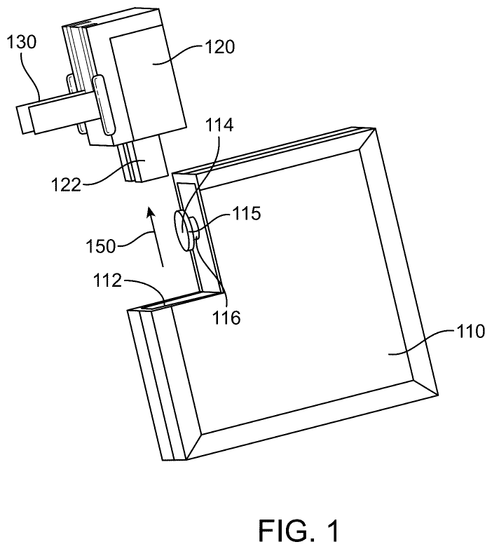

FIG. 1 illustrates a locking plug and power adapter according to an embodiment of the present invention. This figure as with the other included figures is shown for illustrative purposes and does not limit either the embodiments of the present invention or the claims.

Locking plug 120 can include prongs 130 for mating with openings in a wall outlet. Locking plug 120 can include nose 122. Nose 122 can include contacts that can mate with contacts in opening 112 of power adapter 110 when locking plug 120 is mated with power adapter 110. Power adapter 110 can include connectors (not shown) that accept plugs for power cables, data cables, or other connections.

Power adapter 110 can include tab 114. Tab 114 can fit in a slot (not shown) when locking plug 120 is mated with power adapter 110. Typical plugs can be removed from power adapter 110 by pulling locking plug in direction 150. A wire in locking plug 120 can provide a retention force to provide a tactile response to a user when locking plug 120 is removed.

In some circumstances, it can be desirable to limit or prevent the removal of locking plug 120 from power adapter 110. For example, locking plug 120 might become misplaced if removed from power adapter 110. Accordingly, embodiments of the present invention can provide a locking plug 120 that locks to power adapter 110. In one example, locking plug 120 can be glued to power adapter 110. In other embodiments of the present invention, it can be desirable to be able to unlock locking plug 120 and remove it from power adapter 110. In such a locking plug, a tool can be used to unlock locking plug 120 from power adapter 110. The tool can be inserted into one of locking plug 120 or power adapter 110 to unlock locking plug 120. For example, the tool can be inserted into an opening in locking plug 120. This opening can be inconspicuous. An example is shown in the following figure.

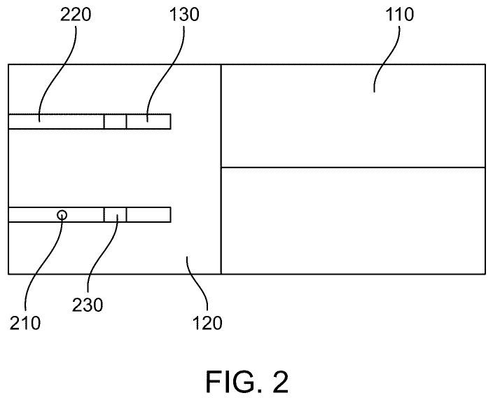

FIG. 2 illustrates a locking plug and power adapter with an unlock passage according to an embodiment of the present invention. Locking plug 120 can include prongs 130. Prongs 130 can extend from locking plug 120 when mated with a corresponding wall outlet. Prongs 130 can be folded down into slots 220 for transport. Locking plug 120 can be attached to power adapter 110 as shown.

Locking plug 120 can include passage or opening 210. Opening 210 can be positioned in a slot 220. Opening 210 can be below a prong 130 when prongs 130 are folded down for transport in slots 220. When prongs 130 are raised, opening 210 can be accessible.

Different locking mechanisms can be used in these and other embodiments of the present invention. These can involve including a locking mechanism in locking plug 120 that blocks the movement of tab 114 in the direction 150 (shown in FIG. 1), thereby preventing the removal of locking plug 120. These locking mechanisms can be moved to release tab 114 and allow locking plug 120 to be removed from power adapter 110.

Various tools can be inserted into opening 210 to unlock locking plug 120 from power adapter 110 in these and other embodiments of the present invention. For example, a tool such as a straightened paper clip can be pushed into opening 210. An internal plate can be pushed out of the way by the tool, thereby releasing tab 114 and allowing locking plug 120 to be removed from power adapter 110. A tool can include a magnet that can be used to move an internal magnet, thereby releasing tab 114 and allowing locking plug 120 to be removed from power adapter 110. Examples are shown in the following figures.

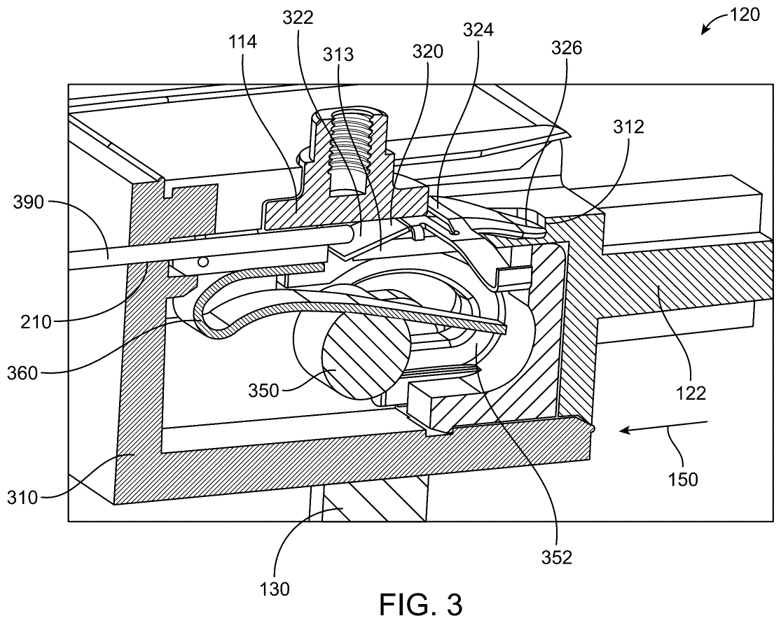

FIG. 3 illustrates a locking plug according to an embodiment of the present invention. When locking plug 120 is locked to power adapter 110 (shown in FIG. 1), a locking mechanism in locking plug 120 can secure tab 114 in place in locking plug 120 thereby preventing the removal of locking plug 120 from power adapter 110. That is, locking plug 120 is prevented from moving in the direction 150 relative to tab 114. In this example, the locking mechanism can be locking bar 324, which can prevent locking plug 120 from moving in the direction 150 relative to tab 114, in the absence of excessive force.

Locking plug 120 can include housing 310 supporting nose 122 and prongs 130. Tab 114 of power adapter 110 can lock locking plug 120 to power adapter 110. Specifically, locking plug 120 can include locking spring 320. Locking spring 320 can include locking bar 324, strike plate 322, and support end 326. Strike plate 322 can be supported by housing 310 at location 313 and support end 326 can be supported by housing 310 at location 312. This can help to keep locking bar engaged with tab 114, thereby preventing the removal of locking plug 120 from power adapter 110. In this position, locking spring 320 can be in a non-deflected position.

In this example, locking spring 320 can be manipulated with an external tool such as a straightened paper clip or other tool 390. Specifically, tool 390 can be placed in opening 210 and pushed into locking plug 120 until tool 390 reaches strike plate 322. Pressure can be applied to strike plate 322. Tool 390 can push strike plate 322 away from tab 114. Locking bar 324 can be pushed down (as drawn) out of the way of tab 114 into a deflected position, thereby freeing locking plug 120 to move in the direction 150 for removal.

After removal, strike plate 322 can remain supported by housing 310 at location 313 and support end 326 can remain supported by housing 310 at location 312. Locking spring 320 can return to its non-deflected position.

When locking plug 120 is reattached to power adapter 110, locking plug 120 can move counter to direction 150. Tab 114 can engage the sloped surface of locking bar 324, which can push locking spring 320 into its deflected position. As locking plug 120 moves counter to direction 150, locking spring 320 can be further deflected. Once tab 114 moves beyond locking bar 324, the deflection force applied to locking spring 320 can be removed and locking spring 320 can return to its non-deflected position (as shown), thereby securing locking plug 120 to power adapter 110.

Locking plug 120 can include prongs 130. Prongs 130 can be arranged to fit in a wall outlet. The particular shape of prongs 130 can vary depending on the wall outlets used in various countries. Prongs can rotate between a closed position where they are located in slots 220 (shown in FIG. 2) and an open position where they extend from housing 310 of locking plug 120. Prongs 130 can rotate between these positions around pivot 350. Pivot 350 can move in guide 352. Spring 360 can apply force to pivot 350 to provide a tactile response when prongs 130 are moved between the open and the closed position.

In this example, tool 390 can be a straightened paperclip or similar structure. In these and other embodiments of the present invention, opening 210 can be narrower than a conventional paperclip width and a specialized tool might be necessary. This can help to avoid inadvertent or undesirable removal of locking plug 120 from power adapter 110.

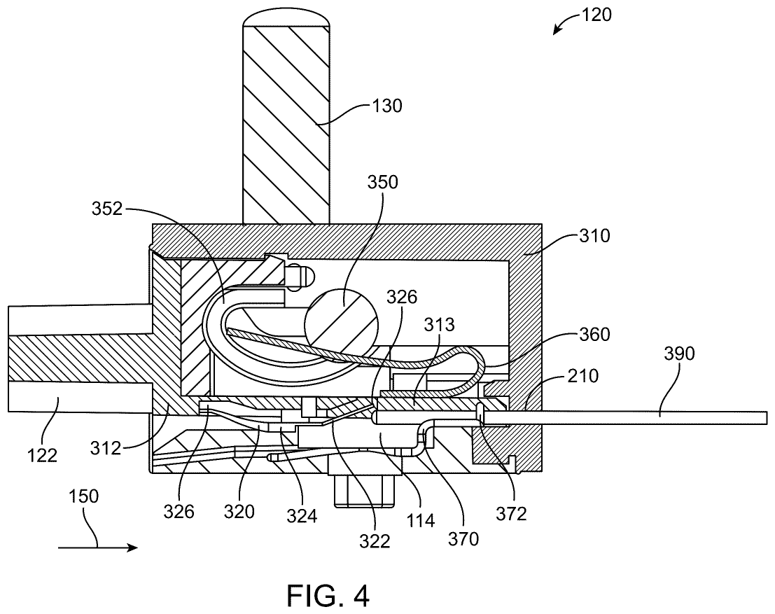

FIG. 4 illustrates another locking plug according to an embodiment of the present invention. When locking plug 120 is locked to power adapter 110 (shown in FIG. 1), a locking mechanism in locking plug 120 can secure tab 114 in place in locking plug 120 thereby preventing the removal of locking plug 120 from power adapter 110. That is, locking plug 120 can be prevented from moving in direction 150 relative to tab 114. In this example, the locking mechanism can be locking bar 324, which can prevent locking plug 120 from moving in the direction 150 relative to tab 114, in the absence of excessive force.

Locking plug 120 can include housing 310 supporting nose 122 and prongs 130. Tab 114 of power adapter 110 can lock locking plug 120 to power adapter 110. Specifically, locking plug 120 can include locking spring 320. Locking spring 320 can include locking bar 324, strike plate 322, and support end 326. Strike plate 322 can be supported by housing 310 at location 313 and support end 326 can be supported by housing 310 at location 312. This can help to keep locking bar 324 engaged with tab 114, thereby preventing the removal of locking plug 120 from power adapter 110. In this position, locking spring 320 can be in a non-deflected position.

In this example, locking spring 320 can be manipulated with an external tool such as a straightened paper clip or other tool 390. Specifically, tool 390 can be placed in opening 210, guided by loop 372 of locking wire 370, and pushed into locking plug 120 until tool 390 reaches strike plate 322. Pressure can be applied to strike plate 322. Tool 390 can push strike plate 322 away from tab 114. Locking bar 324 can be pushed up (as drawn) out of the way of tab 114 into a deflected position, thereby freeing locking plug 120 to move in the direction 150 for removal.

After removal, strike plate 322 can remain supported by housing 310 at location 313 and support end 326 can remain supported by housing 310 at location 312. Locking spring 320 can return to its non-deflected position.

When locking plug 120 is reattached to power adapter 110, locking plug 120 can move counter to direction 150. Tab 114 can engage the sloped surface of locking bar 324, which can push locking spring 320 into its deflected position. As locking plug 120 moves counter to direction 150, locking spring 320 can be further deflected. Once tab 114 moves beyond locking bar 324, the deflection force on locking spring 320 can be removed and locking spring 320 can return to its non-deflected position (as shown), thereby securing locking plug 120 to power adapter 110.

Locking plug 120 can include prongs 130. Prongs 130 can be arranged to fit in a wall outlet. The particular shape of prongs 130 can vary depending on the wall outlets used in various countries. Prongs can rotate between a closed position where they are located in slots 220 (shown in FIG. 2) and an open position where they extend from housing 310 of locking plug 120. Prongs 130 can rotate between these positions around pivot 350. Pivot 350 can move in guide 352. Spring 360 can apply force to pivot 350 to provide a tactile response when prongs 130 are moved between the open and the closed position.

In this example, tool 390 can be a straightened paperclip or similar structure. In these and other embodiments of the present invention, opening 210 can be narrower than a conventional paperclip width and a specialized tool might be necessary. This can help to avoid inadvertent or undesirable removal of locking plug 120 from power adapter 110. In this example, loop 372 of locking wire 370 can guide tool 390 towards strike plate 322. Locking wire can be used to provide a tactile response to the removal of locking plug 120 from power adapter 110 when locking plug is unlocked.

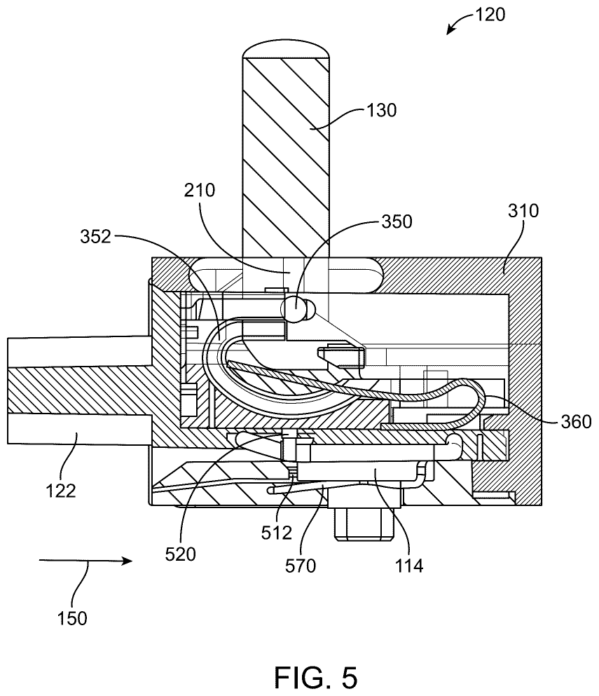

FIG. 5 illustrates another locking plug according to an embodiment of the present invention. When locking plug 120 is locked to power adapter 110 (shown in FIG. 1), a locking mechanism in locking plug 120 can secure tab 114 in place in locking plug 120 thereby preventing the removal of locking plug 120 from power adapter 110. That is, locking plug 120 can be prevented from moving in direction 150 relative to tab 114. In this example, the locking mechanism can be locking magnet 512, which can prevent locking plug 120 from moving in the direction 150 relative to tab 114, in the absence of excessive force.

Locking plug 120 can include housing 310 supporting nose 122 and prongs 130. Tab 114 of power adapter 110 can lock locking plug 120 to power adapter 110. Specifically, locking plug 120 can include locking magnet 512. Locking magnet 512 can be secured in a lateral direction by housing 310 and can move vertically (as drawn) in passage 520.

In this example, locking magnet 512 can be manipulated with an external tool such as a magnet on a supporting length or other tool (not shown). Specifically, this tool can be placed in opening 210 and lowered until it reaches passage 520. The magnet of this tool can pull locking magnet 512 upwards (as drawn) and away from tab 114. This can allow locking plug 120 to move in the direction 150 for removal from power adapter 110. After removal, locking magnet 512 can return to its original position.

When locking plug 120 is reattached to power adapter 110, locking plug 120 can move counter to direction 150. Tab 114 can engage the sloped surface of locking magnet 512, which can push locking magnet 512 upward (as drawn) into its deflected position. As locking plug 120 moves counter to direction 150, locking magnet 512 can be further deflected. Once tab 114 moves beyond locking magnet 512, the deflection force on locking magnet 512 can be removed and locking magnet 512 can return to its non-deflected position (as shown), thereby securing locking plug 120 to power adapter 110.

Locking plug 120 can include prongs 130. Prongs 130 can be arranged to fit in a wall outlet. The particular shape of prongs 130 can vary depending on the wall outlets used in various countries. Prongs can rotate between a closed position where they are located in slots 220 (shown in FIG. 2) and an open position where they extend from housing 310 of locking plug 120. Prongs 130 can rotate between these positions around pivot 350. Pivot 350 can move in guide 352. Spring 360 can apply force to pivot 350 to provide a tactile response when prongs 130 are moved between the open and the closed position.

In this example, tool 390 can be a straight wire with a magnet on one end, a long magnet, or similar structure. In these and other embodiments of the present invention, opening 210 can be narrower than a conventional paperclip width and a specialized tool might be necessary. This can help to avoid inadvertent or undesirable removal of locking plug 120 from power adapter 110.

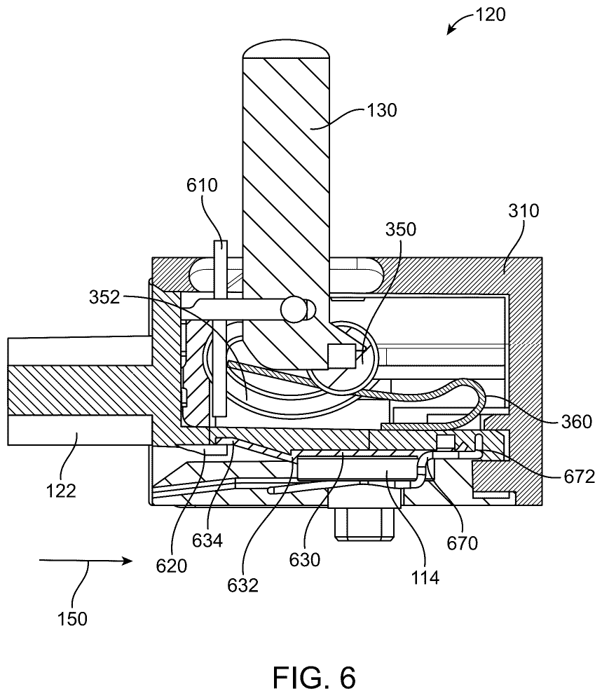

FIG. 6 illustrates another locking plug according to an embodiment of the present invention. When locking plug 120 is locked to power adapter 110 (shown in FIG. 1), a locking mechanism in locking plug 120 can secure tab 114 in place in locking plug 120 thereby preventing the removal of locking plug 120 from power adapter 110. That is, locking plug 120 can be prevented from moving in direction 150 relative to tab 114. In this example, the locking mechanism can be locking spring 630, which can prevent locking plug 120 from moving in the direction 150 relative to tab 114, in the absence of excessive force.

Locking plug 120 can include housing 310 supporting nose 122 and prongs 130. Tab 114 of power adapter 110 can lock locking plug 120 to power adapter 110. Specifically, locking plug 120 can include locking spring 630. Locking spring 630 can include locking edge 632 for holding tab 114 in place and end 634. End 634 can be moved by magnet 620 such that locking edge 632 can be moved to allow the removal of locking plug 120.

In this example, magnet 620 can be manipulated with an external tool such as a magnetic tool 610. Specifically, magnetic tool 610 can be placed in opening 210 and lowered until it is near magnet 620. The magnet of tool 690 can pull magnet 620 upwards (as drawn.) This can pull up end 634 of locking spring 630, which can allow locking plug 120 to move in the direction 150 for removal from power adapter 110. After removal, magnetic tool 610 can be removed and magnet 620 can return to its original position.

When locking plug 120 is reattached to power adapter 110, locking plug 120 can move counter to direction 150. Tab 114 can engage the sloped surface of locking spring 630, which can push locking spring 630 upward (as drawn) into its deflected position. As locking plug 120 moves counter to direction 150, locking spring 630 can be further deflected. Once tab 114 moves beyond locking edge 632, the deflection force on locking spring 630 can be removed and locking spring 630 can return to its non-deflected position (as shown), thereby securing locking plug 120 to power adapter 110.

Locking plug 120 can include prongs 130. Prongs 130 can be arranged to fit in a wall outlet. The particular shape of prongs 130 can vary depending on the wall outlets used in various countries. Prongs can rotate between a closed position where they are located in slots 220 (shown in FIG. 2) and an open position where they extend from housing 310 of locking plug 120. Prongs 130 can rotate between these positions around pivot 350. Pivot 350 can move in guide 352. Spring 360 can apply force to pivot 350 to provide a tactile response when prongs 130 are moved between the open and the closed position.

In this example, tool 390 can be a straight wire with a magnet on one end, a long magnet, or similar structure. In these and other embodiments of the present invention, opening 210 can be narrower than a conventional paperclip width and a specialized tool might be necessary. This can help to avoid inadvertent or undesirable removal of locking plug 120 from power adapter 110.

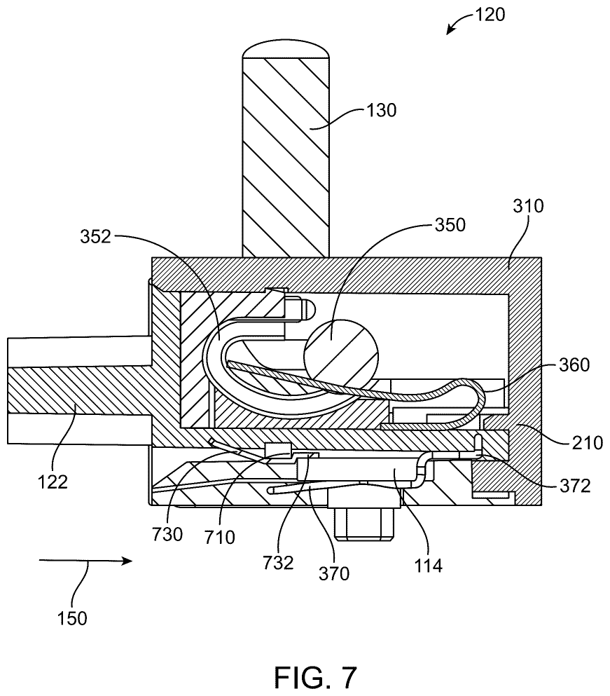

FIG. 7 illustrates another locking plug according to an embodiment of the present invention. When locking plug 120 is locked to power adapter 110 (shown in FIG. 1), a locking mechanism in locking plug 120 can secure tab 114 in place in locking plug 120 thereby preventing the removal of locking plug 120 from power adapter 110. That is, locking plug 120 can be prevented from moving in direction 150 relative to tab 114. In this example, the locking mechanism can be sliding magnet 710, which can prevent locking plug 120 from moving in the direction 150 relative to tab 114, in the absence of excessive force.

Locking plug 120 can include housing 310 supporting nose 122 and prongs 130. Tab 114 of power adapter 110 can lock locking plug 120 to power adapter 110. Specifically, locking plug 120 can include sliding magnet 710. Sliding magnet 710 can be supported by slide 730. Slide 730 can include locking edge 732 for holding tab 114 in place. Sliding magnet 710 can be moved to allow locking edge 732 of slide 730 to release tab 114, thereby allowing the removal of locking plug 120.

In this example, sliding magnet 710 can be manipulated with an external tool such as a magnetic tool (not shown.) Specifically, this tool can be placed in opening 210 and pushed into locking plug 120 until it reaches sliding magnet 710. The tool can be guided by loop 372 of locking wire 370. The magnet of the tool can pull sliding magnet 710 in the direction 150. This can allow locking plug 120 to move in the direction 150 for removal from power adapter 110. After removal, the tool can be removed and sliding magnet 710 can return to its original position.

When locking plug 120 is reattached to power adapter 110, locking plug 120 can move counter to direction 150. Tab 114 can engage the sloped surface of slide 730, which can push slide 730 upward (as drawn) into its deflected position. As locking plug 120 moves counter to direction 150, slide 730 can be further deflected. Once tab 114 moves beyond locking edge 732, the deflection force on slide 730 can be removed and slide 730 can return to its non-deflected position (as shown), thereby securing locking plug 120 to power adapter 110.

Locking plug 120 can include prongs 130. Prongs 130 can be arranged to fit in a wall outlet. The particular shape of prongs 130 can vary depending on the wall outlets used in various countries. Prongs can rotate between a closed position where they are located in slots 220 (shown in FIG. 2) and an open position where they extend from housing 310 of locking plug 120. Prongs 130 can rotate between these positions around pivot 350. Pivot 350 can move in guide 352. Spring 360 can apply force to pivot 350 to provide a tactile response when prongs 130 are moved between the open and the closed position.

In this example, the tool can be a straight wire with a magnet on one end, a long magnet, or similar structure. In these and other embodiments of the present invention, opening 210 can be narrower to help to avoid inadvertent or undesirable removal of locking plug 120 from power adapter 110.

In some circumstances, it can be undesirable to lock a plug to a power adapter. Customer confusion can result and unlocking tools can be lost. Instead of providing a locking feature, these and other embodiments of the present invention can provide retention features that can secure a plug to a power adapter. These retention features can provide a retention force that can secure the plug in place in the power adapter during use. This retention force can be overcome by a user wishing to remove the plug from the power adapter.

These retention features can include springs or other features that act to secure a tab on the power adapter in a slot in a plug. In these and other embodiments of the present invention, springs can be located in the slot in the plug to retain a tab on the power adapter. The springs can include a first spring having two arms. Each arm can include a side protrusion such that the two side protrusions and an end of the first spring form a retention area for the tab on the power adapter. The springs can further include two inclined second springs that attach to ends of each arm of the first spring and extend towards the retention area and away from the first spring. The second springs can terminate in contacting surfaces. The contacting surfaces can engage and provide a force to a bottom of a head of the tab of the power adapter, thereby further securing the tab of the power adapter in place in the slot in the plug. An example is shown in the following figures.

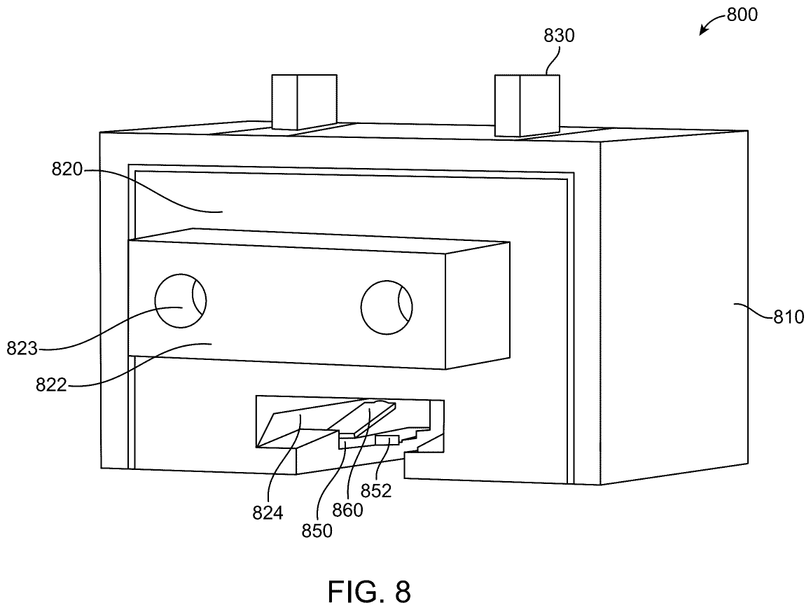

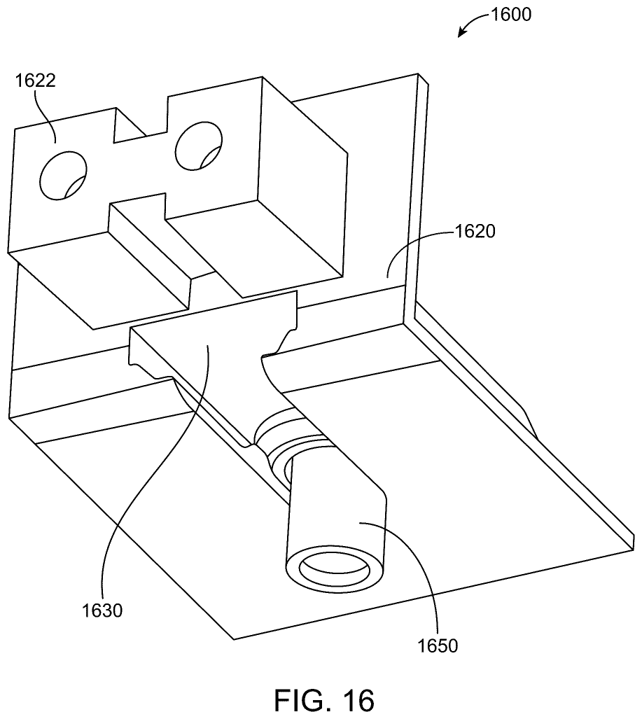

FIG. 8 illustrates a plug having a slot for a retention feature according to an embodiment of the present invention. Plug 800 can include an enclosure formed of an outer housing 810 and an inner housing 820. Nose 822 can extend from inner housing 820. Slot 824 can be formed in inner housing 820. Slot 824 can be arranged to accept head 115 and shaft 116 of tab 114 of power adapter 110 (all shown in FIG. 1.) Nose 822 can provide the same or similar function as nose 122 (shown in FIG. 1.) Plug 1600 (shown in FIG. 16), plug 800, and plug 120 (shown in FIG. 1) can each perform the same or similar functions. Prongs 830 can be arranged to fit in a wall outlet. Power received at prongs 830 can be provided at contacts (not shown) in openings 823 in nose 822 to corresponding contacts (not shown) in power adapter 110.

Slot 824 can include retention features to retain tab 114 of power adapter 110 when power adapter 110 and plug 800 are mated. Slot 824 can include a spring assembly including first spring 850 and second spring 860. First spring 850 and second spring 860 can be formed as separate springs or as a single unitary spring. A third spring 870 can be positioned out of view in the opposing side of slot 824. First spring 850, second spring 860, and third spring 870 can be formed as individual springs or two or more of first spring 850, second spring 860, and third spring 870 can be combined in a unitary structure.

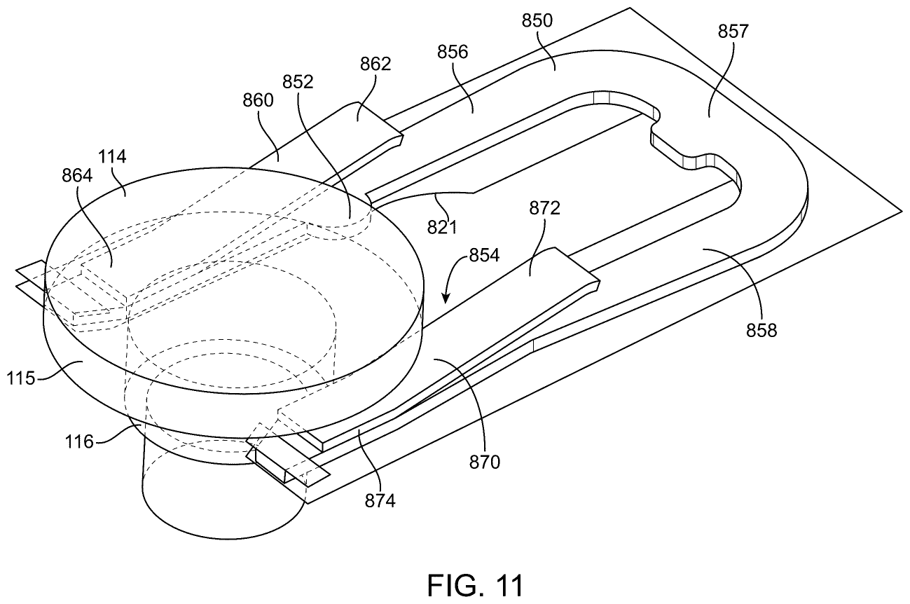

When plug 800 is mated with power adapter 110, head 115 of tab 114 of power adapter 110 can be inserted into the wider, upper portion of slot 824, while the narrower shaft can be inserted into the narrower, lower portion of slot 824. Head 115 of tab 114 can engage second spring 860 and third spring 870, deflecting them downward (as drawn.) Shaft 116 can engage protrusion 852 and protrusion 854 (shown in FIG. 11) on first spring 850, deflecting first arm 856 and second arm 858 (both shown in FIG. 11) of first spring 850 away from each other. When tab 114 is fully inserted, first arm 856 and second arm 858 of first spring 850 can return to a relaxed position. Shaft 116 and head 115 of tab 114 can be retained in a retention area defined in part by first protrusion 852 and second protrusion 854 of first spring 850. Contacting surface 862 of second spring 860 and contacting surface 872 of third spring 870 (all shown in FIG. 11) can engage and provide an upward force on an underside of head 115 of tab 114.

When plug 800 is separated from power adapter 110, shaft 116 can engage first protrusion 852 and second protrusion 854 on first spring 850, deflecting first arm 856 and second arm 858 of first spring 850 away from each other.

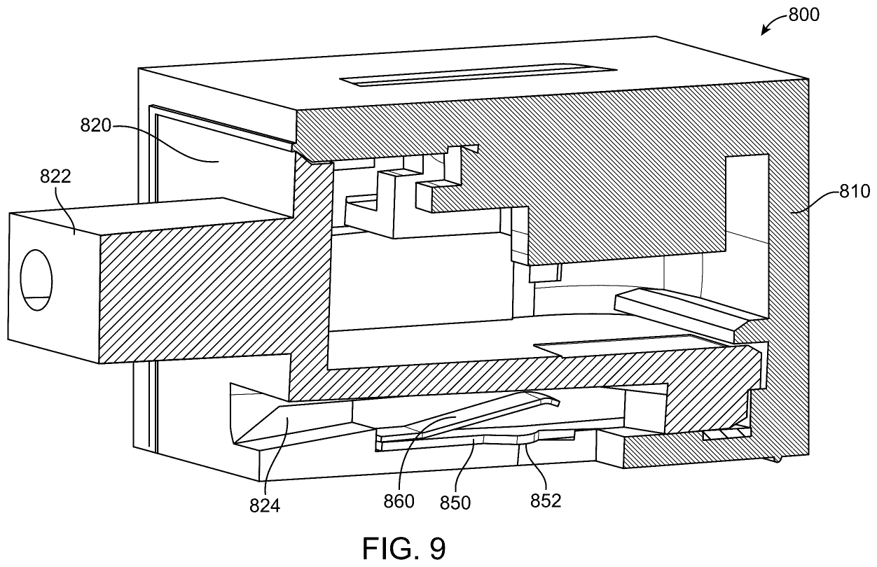

FIG. 9 illustrates a cutaway side-view of a plug having a slot and a retention feature according to an embodiment of the present invention. Plug 800 can include outer housing 810 and inner housing 820. Nose 822 can extend from inner housing 820. Slot 824 can extend into inner housing 820. Slot can support a spring assembly for retaining head 115 and shaft 116 on tab 114 (all shown in FIG. 1.) The spring assembly can include first spring 850 and second spring 860. First spring 850 can include protrusion 852. Third spring 870 has been removed for this cutaway view. First spring 850, second spring 860, and third spring 870 can be formed separately, as a single unitary piece, or as two or more individual pieces.

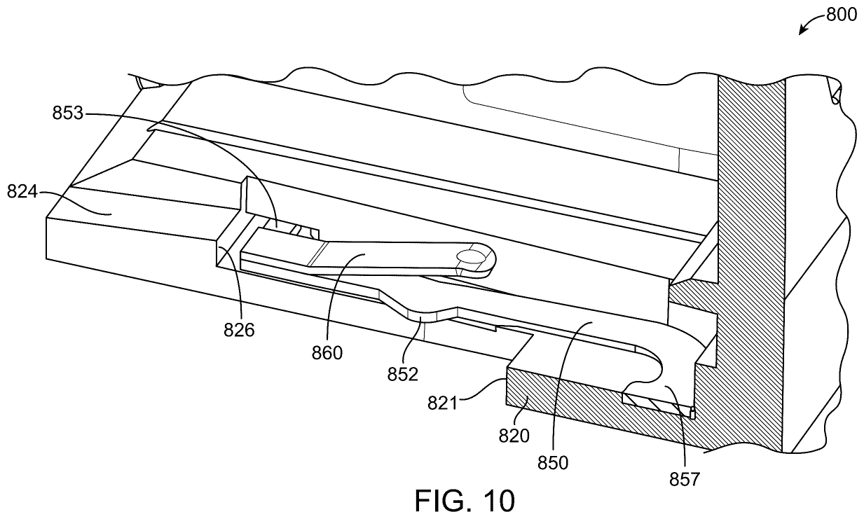

FIG. 10 illustrates cutaway side-view of a portion of a plug having a slot and a retention feature according to an embodiment of the present invention. Slot 824 can be formed in inner housing 820. First spring 850 and second spring 860 can be positioned in slot 824. First spring can include joining portion 857.

As tab 114 (shown in FIG. 1) is inserted and removed from slot 824 in inner housing 820 of plug 800, it can be desirable to protect first spring 850 and second spring 860 from damage. Accordingly, first spring 850 can include extended portion 853 Extended portion 853 can help to keep first spring 850 in place. Also, slot 824 can include edge 826. Edge 826 can shield first spring 850 and second spring 860 when tab 114 is inserted.

When plug 800 is mated with power adapter 110, shaft 116 and head 115 of tab 140 of power adapter 110 can be positioned in a retention area in slot 824. The retention area can be defined by protrusion 852 and protrusion 854 (shown in FIG. 11) of first spring 850. The retention area can further be defined by end or narrowed portion 821 of slot 824 of inner housing 820.

FIG. 11 illustrates a retention feature for a plug according to an embodiment of the present invention. This retention feature can include first spring 850, second spring 860, and third spring 870. First spring 850, second spring 860, and third spring 870 can be formed separately, as a single unitary piece, or as two or more individual pieces.

First spring 850 can include first arm 856 and second arm 858 joined by joining portion 857. First arm 856 can include first protrusion 852 and second arm 858 can include second protrusion 854. First protrusion 852 can be wider than some or all of first arm 856 and second protrusion 854 can be wider than some or all of second arm 858. Second spring 860 can include contacting surface 862. Third spring 870 can include contacting surface 872. When head 115 and shaft 116 of tab 114 are inserted into slot 824, shaft 116 can encounter first protrusion 852 and second protrusion 854. This can push first arm 856 and second arm 858 away from each other to allow tab 114 to reach the retention area. When plug 800 (shown in FIG. 8) and power adapter 110 (shown in FIG. 1) are mated, head 115 and shaft 116 of tab 114 can be in the retention area, and contacting surface 862 of second spring 860 and contacting surface 872 of third spring 870 can encounter and provide a force against a bottom of head 115 of tab 114, thereby helping to retain tab 114 in slot 824 (shown in FIG. 8.) The retention area can be formed by first protrusion 852, second protrusion 854, and an end or narrowed portion 821 of slot 824 (shown in FIG. 8.)

Second spring 860 can be attached to first spring 850 at location 864 by soldering or spot or laser welding. Third spring 870 can be attached to first spring 850 at location 874 by soldering or spot or laser welding. Alternatively, second spring 860 can be formed with first spring 850, third spring 870 can be formed with first spring 850, or both second spring 860 and third spring 870 can be formed with first spring 850.

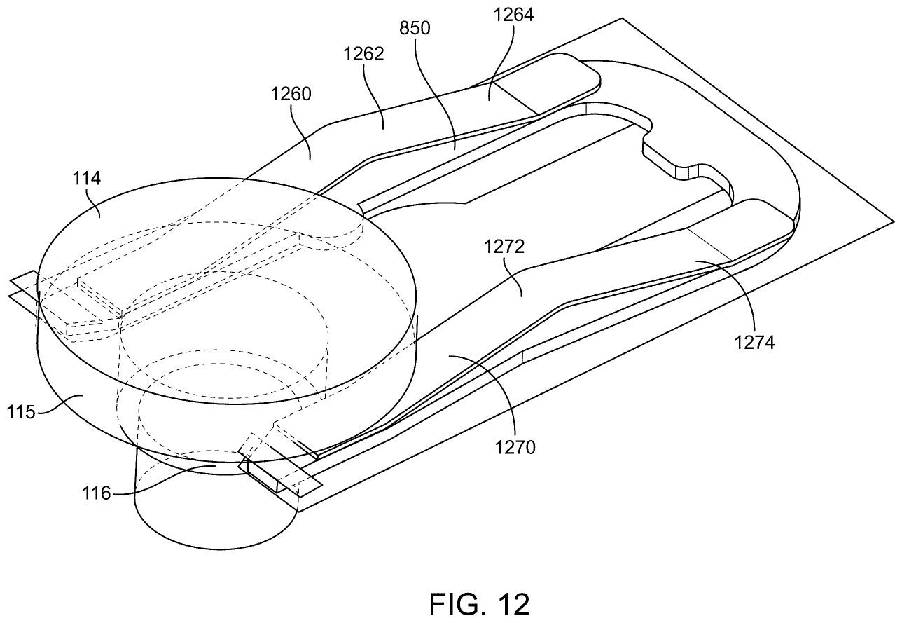

FIG. 12 illustrates another retention feature for a plug according to an embodiment of the present invention. This retention feature can include first spring 850, second spring 1260, and third spring 1270. First spring 850, second spring 1260, and third spring 1270 can be formed separately, as a single unitary piece, or as two or more individual pieces.

Second spring 1260 can include extended portion 1264 and contacting surface 1262. Third spring 1270 can include extended portion 1274 and contacting surface 1272. The addition of extended portion 1264 to second spring 1260 and extended portion 1274 to third spring 1270 can provide an additional flex beam for second spring 1260 and third spring 1270, thereby helping to prevent wear and cracking during use.

When plug 800 (shown in FIG. 8) and power adapter 110 (shown in FIG. 1) are mated, head 115 and shaft 116 of tab 114 can be in the retention area, and contacting surface 1262 of second spring 1260 and contacting surface 1272 of third spring 1270 can encounter and provide a force against a bottom of head 115 of tab 114, thereby helping to retain tab 114 in slot 824 (shown in FIG. 8.)

Second spring 1260 can be attached to first spring 850 by soldering or spot or laser welding. Third spring 1270 can be attached to first spring 850 by soldering or spot or laser welding. Alternatively, second spring 1260 can be formed with first spring 850, third spring 1270 can be formed with first spring 850, or both second spring 1260 and third spring 1270 can be formed with first spring 850. An example of forming springs together is shown in the following figure.

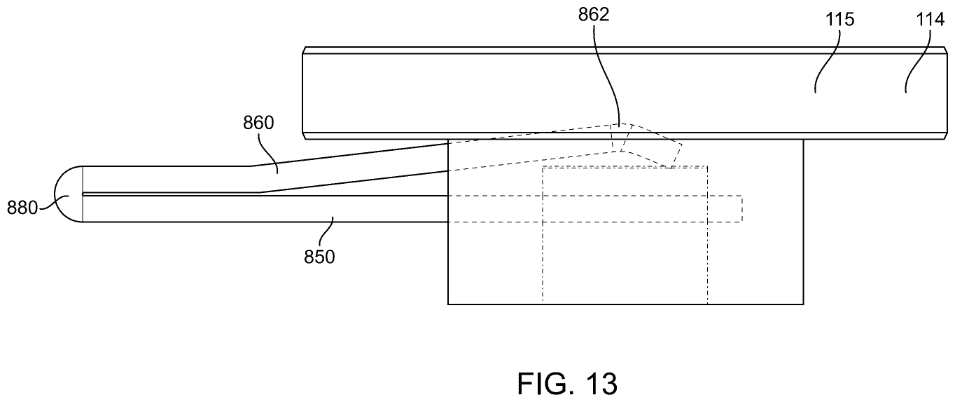

FIG. 13 illustrates a side-view of another retention feature for a plug according to an embodiment of the present invention. In this example, tab 114 has been moved to the retention area. Contacting surface 862 of second spring 860 can contact an underside of head 115 of tab 114. Second spring 860 and first spring 850 can be formed together and joined by fold 880. Fold 880, and the other features of the combined second spring 860 and first spring 850 can be formed by stamping, printing, forging, or other process.

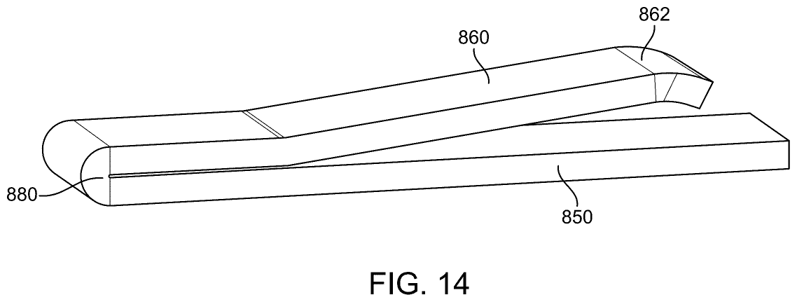

FIG. 14 is an oblique view of a retention feature for a plug according to an embodiment of the present invention. First spring 850 and second spring 860 can be formed together and joined by fold 880. Second spring 860 can include contacting surface 862.

As shown in FIG. 11, first spring 850 can include first protrusion 852 on first arm 856 and second protrusion 854 on second arm 858. As tab 114 is moved to the retention area in slot 824, shaft 116 can push first protrusion 852 and second protrusion 854, thereby moving first arm 856 and second arm 858 away from each other. This movement can induce a twisting motion in either or both first arm 856 and second arm 858. Accordingly, embodiments of the present invention can provide reinforcements on first protrusion 852 on first arm 856 and second protrusion 854 on second arm 858. These reinforcements can help to avoid or limit the twisting of first arm 856 and second arm 858. An example is shown in the following figure.

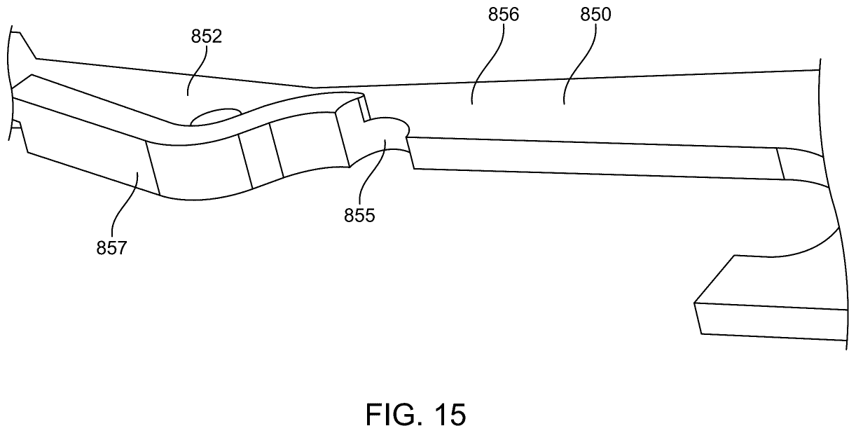

FIG. 15 is a detailed view of a portion of a retention feature for a plug according to an embodiment of the present invention. First spring 850 can include first protrusion 852 on first arm 856. When plug 800 (shown in FIG. 8) and power adapter 110 (shown in FIG. 1) are mated, tab 114 can be moved to the retention area in slot 824. As that happens, shaft 116 can push first protrusion 852 and second protrusion 854, thereby moving first arm 856 and second arm 858 away from each other. This movement can induce a twisting motion in either or both first arm 856 and second arm 858. Accordingly, embodiments of the present invention can provide reinforcements on first protrusion 852 on first arm 856 and second protrusion 854 on second arm 858. These reinforcements can help to avoid or limit the twisting of first arm 856 and second arm 858. For example, protrusion 852 can be wider than some or all of the rest of first arm 856 of first spring 850. A raised wall portion 857 can be formed along an outer edge of protrusion 852 for further reinforcement. To improve flexibility, notch 855 can be formed adjacent or near raised wall portion 857. Second protrusion 854 (shown in FIG. 11) can include mirrored or similar features. These reinforcing features can help to prevent or limit twisting of first arm 856 and second arm 858 during mating of plug 800 and power adapter 110.

In the above examples, forces retaining a tab of a power adapter in a slot of a plug can be provided by springs in the slot. In these and other embodiments of the present invention, these forces can be provided by one or more springs in or associated with the tab. For example, a spring can be located in the tab. The tab can include a shaft and a head. The shaft can include a plunger, the plunger attached to the head. The head and plunger can be movable relative to the shaft. The shaft can be fixed to the power adapter. A spring can be positioned to provide a force acting to push the plunger, and therefore the head, towards the power adapter. The slot in the plug can include a recessed portion forming a retention area. Once the tab of the power adapter is positioned in the retention area, the force pushing the head towards the power adapter can act to retain the tab of the power adapter in place. Examples are shown in the following figures.

FIG. 16 illustrates another plug having a slot for a retention feature according to an embodiment of the present invention. Plug 1600 can include an outer housing (not shown) similar to outer housing 810 (shown in FIG. 8.) Plug 1600 can further include inner housing 1620. Inner housing 1620 can include nose 1622 and slot 1630. Nose 1622 can be similar to nose 822 (shown in FIG. 8) and nose 122 (shown in FIG. 1.) Slot 1630 can accept tab 1650. Tab 1650 can perform a similar function as tab 114 (shown in FIG. 1.) Plug 1600, plug 800 (shown in FIG. 8), and plug 120 (shown in FIG. 1) can each perform the same or similar functions. Tab 1650 can be attached to a power adapter, such as power adapter 110 (shown in FIG. 1.) Further details of tab 1650 and slot 1630 are shown in the following figures.

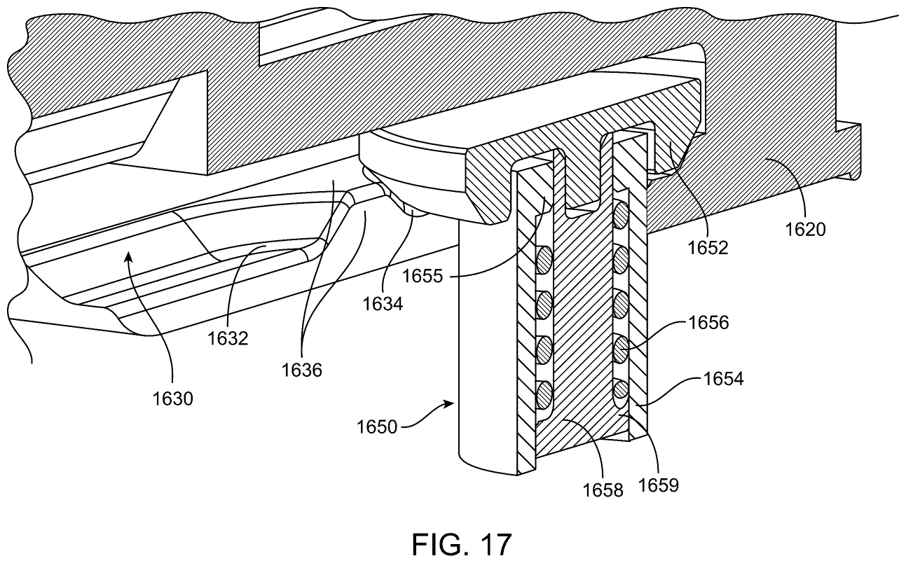

FIG. 17 illustrates a cutaway view of retention features for a plug according to an embodiment of the present invention. These retention features can include tab 1650 and surfaces in slot 1630 of inner housing 1620. When plug 1600 is mated with power adapter 110 (shown in FIG. 1), head 1652 of tab 1650 can be positioned in retention area 1634 in the surface of slot 1630. Spring 1656 in tab 1650 can push down on head 1652, seating it in retention area 1634. This can retain tab 1650 in in place in retention area 1634, thereby securing plug 1600 to power adapter 110.

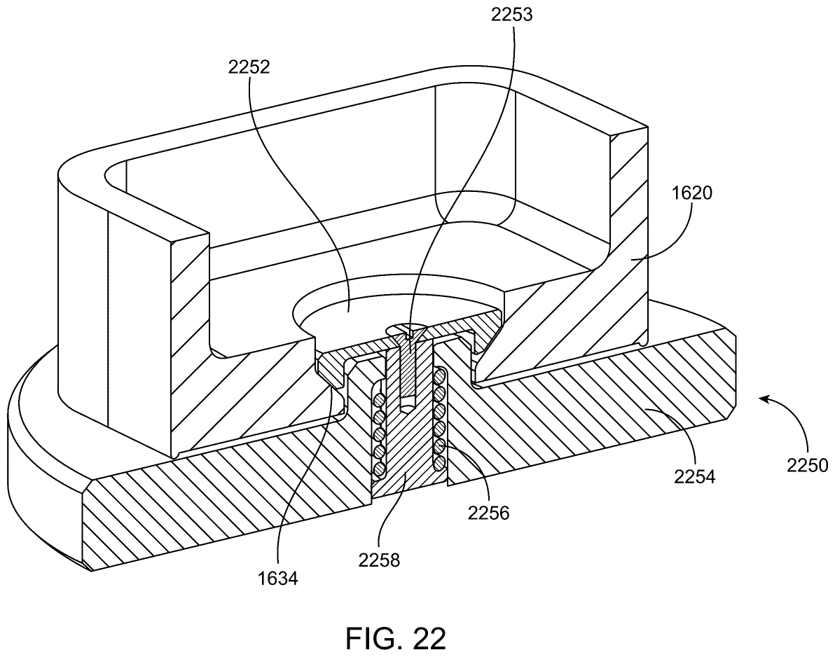

More specifically, tab 1650 can include head 1652. Head 1652 can be attached to plunger 1658, for example using glue or other adhesive, a fastener 2253 (shown in FIG. 22), or other adhering structure. Plunger 1658 can be secured in shaft 1654. Spring 1656 can be around plunger 1658 and inside shaft 1654. Head 1652 and plunger 1658 can be separate pieces for assembly, though in these and other embodiments, head 1652 and plunger 1658 can be formed as a single piece. Shaft 1654 can be attached to a housing or other portion of power adapter 110.

Spring 1656 can be in compression between ledge 1659 of plunger 1658 and ledge 1655 of shaft 1654. With shaft 1654 fixed to the power adapter 110, spring 1656 can push down on plunger 1658. This can pull down on head 1652 of tab 1650, helping to seat it in retention area 1634 in slot 1630.

Slot 1630 can have various contours configured to provide a desired tactile response when a user attached plug 1600 to power adapter 110. For example, slot 1630 can include a recessed portion 1632, leading to a raised portion 1636. A minimal amount of force might need to be exerted to move tab 1650 through recessed portion 1632 up to raised portion 1636. A higher amount of force might be needed when raised portion 1636 is reached. The force necessary for insertion can drop off again once head 1652 of tab 1650 reaches retention area 1634 in slot 1630. The force for extraction can be higher as head 1652 is moved out of retention area 1634 and over raised portion 1636. The force can drop off as head 1652 is moved through recessed portion 1632 and out of slot 1630.

The forces necessary for the insertion and extraction of tab 1650 into and out of slot 1630 can be varied. For example, the depths and the slopes of edges of recessed portion 1632, raised portion 1636, and retention area 1634 can be tailored to provide a desirable insertion and extraction profile. Also, the shape of head 1652 and the characteristics of spring 1656 can be varied to provide a desirable insertion and extraction profile.

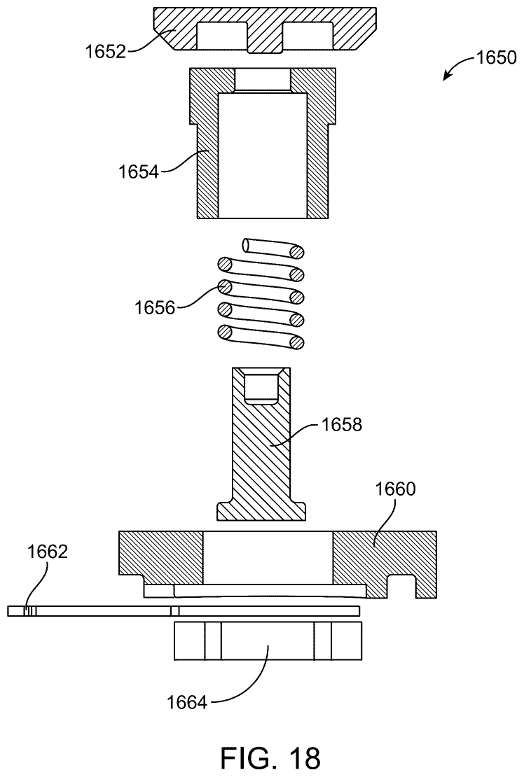

FIG. 18 is an exploded view of a tab for a power adapter according to an embodiment of the present invention. Tab 1650 can include head 1652 and shaft 1654. Head 1652 and shaft 1654 can both be metallic. Spring 1656 can be around plunger 1658 and inside shaft 1654. Spring 1656 can be formed of steel, such a spring steel, or other material. Spring 1656 can be formed to be in compression in tab 1650. Adapter 1660 can be attached to or can form part of an enclosure for power adapter 110. Grounding lug 1662 and retaining nut 1664 or other fastener can attach tab 1650 to power adapter 110.

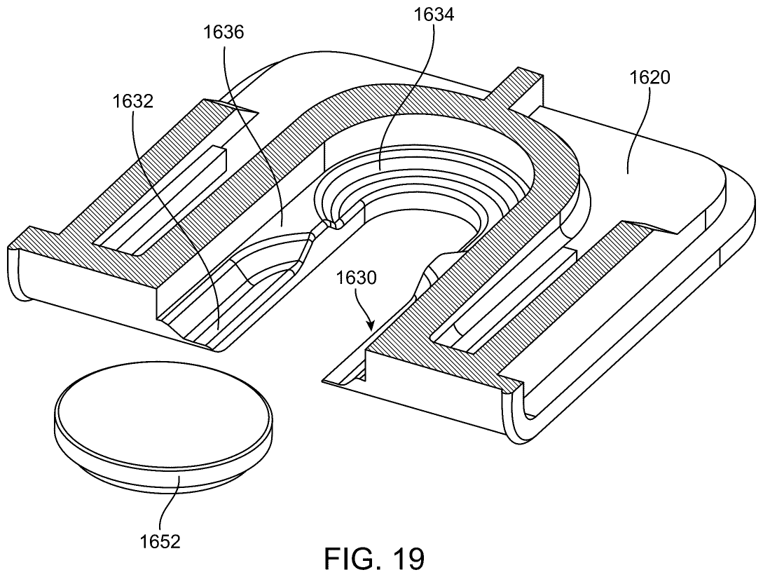

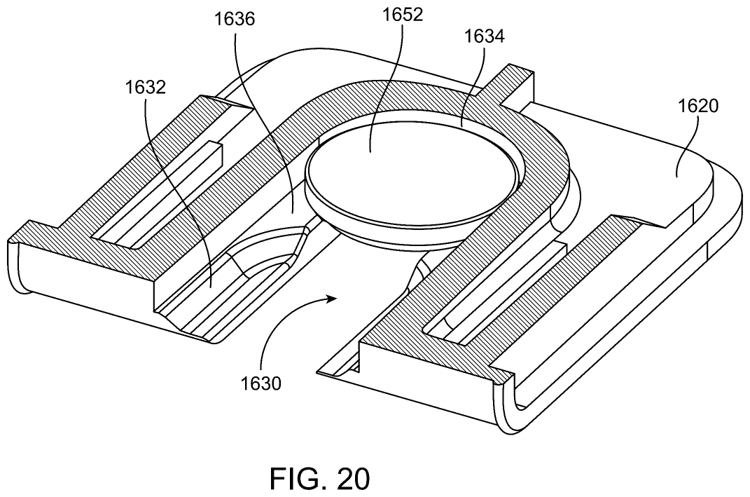

FIG. 19 and FIG. 20 illustrate a surface in a slot of a plug for a retention feature according to an embodiment of the present invention. In FIG. 19, head 1652 is shown as entering slot 1630 as a user is attaching plug 1600 to power adapter 110. Slot 1630 can include recessed portion 1632, raised portion 1636, and retention area 1634 in inner housing 1620.

A minimal amount of force might need to be exerted to move tab 1650 through recessed portion 1632 up to raised portion 1636. A higher amount of force might be needed when raised portion 1636 is reached. The force necessary for insertion can drop off again once head 1652 of tab 1650 reaches retention area 1634 in slot 1630. The force for extraction can be higher as head 1652 is moved out of retention area 1634 and over raised portion 1636. The force can drop off as head 1652 is moved through recessed portion 1632 and out of slot 1630. In FIG. 20, head 1652 is shown as having moved to retention area 1634 after passing through recessed portion 1632 and over raised portion 1636 of slot 1630 in inner housing 1620.

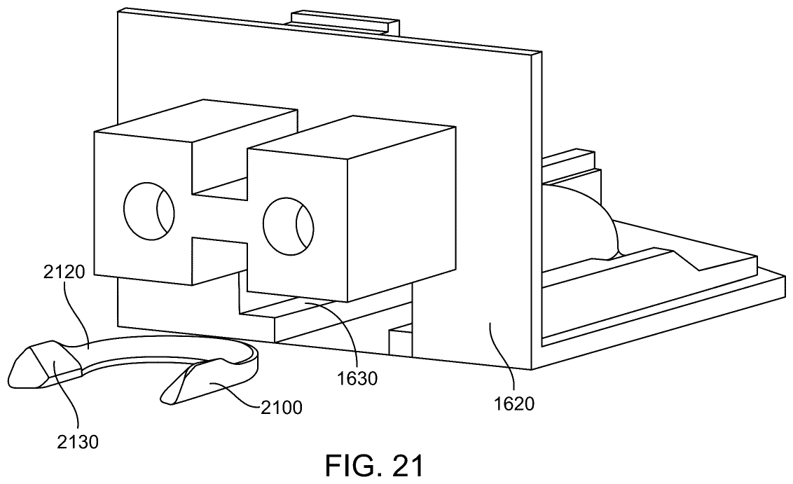

FIG. 21 illustrates a protection structure for a surface in a slot of a plug for a retention feature according to an embodiment of the present invention. In the above examples, head 1652 of tab 1650 can be metallic. This metallic head can slide along slot 1630 in inner housing 1620. Slot 1630 and inner housing 1620 can be formed of a type of plastic or nylon, such as a glass-filled nylon. This movement can cause wear along slot 1630. Accordingly, a portion of slot 1630 can be protected with a metallic piece, such that metal head 1652 of tab 1650 encounters metal in slot 1630. In this example, portion 2120 of metallic piece 2100 can replace or provide protection for retention area 1634 in slot 1630. Raised ends 2130 of metallic piece 2100 can similarly replace or provide protection for raised portion 1636.

FIG. 22 illustrates another retention feature for a plug according to an embodiment of the present invention. In this example, tab 2250 can include head 2252, plunger 2258, and shaft 2254. Spring 2256 can be positioned between shaft 2254 and plunger 2258. Head 2252 can be attached to plunger 2258, for example using screw or other fastener 2253. Tab 2250 is shown seated in retention area 1634 in inner housing 1620.

The components of these power adapters and plugs can be formed of various materials. For example, the tabs, springs, and their constituent parts and other metallic portions of the power adapters can be formed by drawing, machining, stamping, forging, metal-injection molding, machining, micro-machining, 3-D printing, or other manufacturing process. These metallic portions can be formed of stainless steel, steel, copper, copper titanium, phosphor bronze, or other material or combination of materials. They can be plated or coated with one or more layers of nickel, palladium, palladium-nickel, gold, or other material or combination of materials.

The nonmetallic portions, such as the enclosure, housings, and their constituent parts and other nonmetallic portions can be formed using injection or other molding, 3-D printing, machining, or other manufacturing process. The nonmetallic portions can be formed of silicon or silicone, rubber, hard rubber, plastic, nylon, glass-filled nylon, elastomers, liquid-crystal polymers (LCPs), ceramics, polycarbonate, or other nonmetallic material or combination of materials.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A power adapter system comprising:
a power adapter; and
a locking plug, wherein the locking plug comprises a locking mechanism to lock the locking plug to the power adapter.

2. The power adapter system of claim 1 wherein the locking mechanism is unlockable to remove the locking plug from the power adapter.

3. The power adapter system of claim 2 wherein after removal, the locking plug is re-attachable to the power adapter.

4. The power adapter system of claim 3 wherein the locking mechanism is unlocked using a tool.

5. The power adapter system of claim 4 wherein the tool is used to move a portion of the locking mechanism.

6. The power adapter system of claim 5 wherein the locking mechanism comprises a spring that engages a tab on the power adapter.

7. The power adapter system of claim 5 wherein the locking mechanism comprises a magnet.

8. A power adapter system comprising:
a power adapter comprising:
an enclosure; and
a tab extending from the enclosure, the tab comprising a head and a shaft; and
a plug comprising:
an enclosure having a slot to accept the head and shaft of the tab of the power adapter; and
a spring assembly positioned in the slot, wherein the spring assembly comprises:
a first spring having a first arm and a second arm, the first arm having a first protrusion and the second arm having a second protrusion, wherein the first protrusion and the second protrusion form a retention area where the tab of the power adapter is retained in the retention area when the power adapter and plug are mated, and wherein the first protrusion is a widened and reinforced portion of the first arm and the second protrusion is a widened and reinforced portion of the second arm.

9. The power adapter system of claim 8 wherein the first spring further comprises a joining portion connecting the first arm to the second arm.

10. The power adapter system of claim 9 further comprising an inclined second spring attached to a first end of the first arm of the first spring, the second spring extending towards the retention area and away from the first spring.

11. The power adapter system of claim 10 further comprising an inclined third spring attached to a first end of the second arm of the first spring, the third spring extending towards the retention area and away from the first spring.

12. The power adapter system of claim 11 wherein the second spring comprises a first contacting surface and the third spring comprises a second contacting surface, wherein the first contacting surface and the second contacting surface engage a bottom of the head of the tab of the power adapter when the power adapter and the plug are mated.

13. The power adapter system of claim 11 wherein the first spring, the second spring, and the third spring are formed as separate pieces.

14. The power adapter system of claim 11 wherein the first spring, the second spring, and the third spring are formed as a single unitary piece.

15. A power adapter system comprising:
a power adapter comprising:
an enclosure;
a tab extending from the enclosure, the tab comprising a head and a shaft, the shaft fixed to the enclosure, wherein the shaft comprises:
a plunger fixed to the head, wherein the plunger and the head are movable with respect to the shaft; and
a spring between the shaft and the plunger; and
a plug comprising:
an enclosure having a slot to accept the head and shaft of the tab of the power adapter.

16. The power adapter system of claim 15 wherein the spring is positioned to provide a force acting to push the plunger and the head towards the power adapter.

17. The power adapter system of claim 16 wherein the spring is positioned around the plunger and within the shaft.

18. The power adapter system of claim 17 wherein the shaft and the head are metallic.

19. The power adapter system of claim 18, wherein the slot comprises a recessed portion.

20. The power adapter system of claim 19 further comprising a metallic spacer positioned in the recessed portion in the slot of the plug.
